(19) United States
(12) Patent Application Publication
(10) Pub. No.: US 2024/0254048 A1
(43) Pub. Date: Aug. 1, 2024

(54) PLASTER MASS, PLASTER LAYER AND PLASTER SYSTEM

(71) Applicant: STO CORP., Atlanta, GA (US)

(72) Inventors: Richard LeFevre, Kennesaw, GA (US); Daniel Hartley, Peachtree City, GA (US)

(21) Appl. No.: 18/529,159

(22) Filed: Dec. 5, 2023

Related U.S. Application Data
(60) Provisional application No. 63/441,486, filed on Jan. 27, 2023.

(30) Foreign Application Priority Data
May 30, 2023 (EP) 23176136.2

(51) Int. Cl. C04B 26/02; C04B 14/04; C04B 14/26; C04B 24/42

(52) U.S. Cl. CPC C04B 26/02; C04B 14/04; C04B 14/26; C04B 24/42

(57) ABSTRACT

The invention concerns a plaster mass for the formation of a single-layered or multi-layered plaster layer, in particular a reinforcing layer, containing
at least one polymer binder,
fillers,
additives, and
water.

In accordance with the invention, the fillers are present in a particle size distribution which is at least trimodal, comprising
at least one coarse filler with an average particle size D50 of 500-2000 μm, preferably 800-1800 μm, more preferably 1000-1600 μm,
at least one fine filler with an average particle size D50 of 100-500 μm, preferably 150-450 μm, more preferably 180-400 μm, and
at least one finest filler with an average particle size D50 of 5-99 μm, preferably 10-80 μm, more preferably 15-75 μm.

The invention further concerns a single-layered or multi-layered plaster layer as well as a plaster system.

The invention relates to a plaster mass for the formation of a single-layered or multi-layered plaster layer, in particular a reinforcing layer. This means that the plaster layer is preferably reinforced with a reinforcing mesh. A further plaster layer may be applied to the single-layered or multi-layered plaster layer as a top coat. As an alternative or in addition, the single-layered or multi-layered plaster layer may be disposed on a further plaster layer which serves as a base coat.

Furthermore, the invention relates to a single-layered or multi-layered plaster layer formed from a plaster mass in accordance with the invention as well as to a plaster system which comprises a single-layered or multi-layered plaster layer formed from the plaster mass in accordance with the invention.

### PRIOR ART

In plaster layers for exterior use, in particular when they are applied to an insulating layer, the problem of woodpecker damage frequently arises. This means that woodpeckers or other birds knock holes in the plaster layer when seeking out food or nesting places, because to them, the rough surface of the plaster layer resembles tree bark and the hollow noise when pecking is similar to that produced on soft, decayed wood. This gives rise to damage on plaster or thermally insulating composite systems, which not only has a negative effect on the appearance, but also compromises the function thereof.

In order to avoid such damage, the plaster layer or the plaster could be made thicker, so that they can no longer be holed by a bird, in particular a woodpecker. However, increasing the thickness of the plaster will also increase costs. As an alternative or in addition, the plaster surface could be made smooth so that birds can no longer gain a purchase on it. However, this approach to solving the problem curbs design flexibility. Furthermore, the use of a particularly strong reinforcing mesh in the reinforcing layer, what is known as an armour mesh, has been proposed. But even this is not always a full defence against pecking by woodpeckers.

Thus, the objective of the present invention is to prevent or at least alleviate the problem of woodpecker damage in exterior plaster layers or plaster.

The objective is achieved by means of the plaster mass with the features of claim 1. Advantageous further embodiments of the invention are defined in the dependent claims. Furthermore, a single-layered or multi-layered plaster layer as well as a plaster system are defined.

### DISCLOSURE OF THE INVENTION

A plaster mass is proposed for the formation of a single-layered or multi-layered plaster layer, in particular a reinforcing layer, containing
at least one polymer binder,
fillers,
additives, and
water.

In accordance with the invention, the fillers are present in a particle size distribution which is at least trimodal, comprising
at least one coarse filler with an average particle size D50 of 500-2000 μm, preferably 800-1800 μm, more preferably 1000-1600 μm,
at least one fine filler with an average particle size D50 of 100-500 μm, preferably 150-450 μm, more preferably 180-400 μm, and
at least one finest filler with an average particle size D50 of 5-99 μm, preferably 10-80 μm, more preferably 15-75 μm.

The D50 value, also called the median grain size or median value, provides the average particle size of a filler, so that the fraction of particles which are larger than the D50 value is equal to the fraction of particles which are smaller than the D50 value. These values are preferably determined in accordance with DIN ISO 9276-1:2004-09 (Representation of results of particle size analysis—Part 1: graphical representation) and ISO 9276-2:2014-05 (Representation of results of particle size analysis—Part 2: Calculation of average particle sizes/diameters and moments from particle size distributions). In this regard, the Mastersizer 3000 from Malvern Instruments Limited may be used as the instrument for determining the sizes. As a rule, however, these values may also simply be obtained from a technical data sheet.

The proposed filler combination with the given D50 values permits particularly dense packing of the fillers, because the fine fillers settle into the spaces remaining between the coarse fillers and the finest fillers settle into the spaces remaining between the coarse fillers and the fine fillers. The dense packing in turn leads to an increased elasticity and therefore to an increased resistance to pecking of a plaster layer formed from the plaster mass. This is because to a large extent, the pecks are absorbed because of the elasticity of the plaster layer.

Ideally, the determination of the average particle size D50 of the various size fractions is based on the coarse filler fraction as a starting point. This is because they form a kind of scaffolding within the packing. In this scaffolding, spaces remain between the coarse fillers; the size of the spaces can be calculated so that the size of the fine fillers can be established therefrom. This is also the case with the size of the spaces which remain between the coarse fillers and the fine fillers which are to be filled with the finest fillers.

When calculating the remaining spaces between the fillers, for simplification purposes, the particles of a size fraction may be assumed to be spheres of identical size, wherein the size corresponds to the respective D50 value. In reality, the shape of the particles will differ from that of a sphere. In addition, not all of the fillers of a size fraction will have the same size, but are distributed in their sizes. However, when calculating the remaining spaces or when determining the average particle size D50 of the individual size fractions, this can be ignored.

in the case of spheres which are as closely packed as possible, tetrahedral voids and octahedral voids are formed. A smaller sphere with a diameter d will fit into an octahedral void between two particles/spheres of a coarse filler with diameter D if d is in the range 0.155*D to 0.414*D. However, the tetrahedral voids are more crucial. A smaller sphere with a diameter d will fit into a tetrahedral void between two particles/spheres of a coarse filler with diameter D if d is in the range 0.225*D to 0.291*D.

Generalising, it can be said that the D50 value of the fine filler should be between 0.155 and 0.414, preferably between 0.225 and 0.414, more preferably between 0.225 and 0.291 of the D50 value of the coarse filler in order to obtain packing which is as dense as possible.

The D50 value of the finest fillers in this regard should be selected so as to be a factor of 2, preferably a factor of 3, more preferably a factor of 4 times smaller than the D50 value of the fine filler, so that the finest filler fills the voids or spaces remaining between the coarse filler and the fine filler.

Both the quantitative ratio and the volumetric ratio of the at least one coarse filler (CF) to the at least one fine filler (FF) and to the at least one finest filler (FstF) is ideally

$$CF : FF : FstF = 1 : 1.5 - 2.5 : 2 - 4$$

As a result, because of the dense packing of the fillers, a very small residual volume remains which has to be filled with the polymer binder. The dense packing of the fillers therefore has an influence on the pigment volume concentration PVC of the plaster mass or a plaster layer produced therefrom, wherein the PVC designates the ratio of the volume of the pigments and fillers it contains to the total volume of non-volatile components, usually pigments, fillers and binders. Thus, the PVC is an essential factor in the characterisation of the volumetric ratio of pigment and filler to the binder. As a rule, the lower the PVC, the higher is the proportion of binder.

Reference may be made to DIN EN ISO 4618:2015-01 for the determination of the PVC. The following formula may be used to calculate the PVC:

$$PVC [ \% ] = ( \sum {V}_{pigments} + \sum {V}_{fillers} / \sum {V}_{pigments} + \sum {V}_{fillers} + \sum {V}_{binder} ) \times 100$$

The critical pigment volume concentration CPVC constitutes a further essential parameter. DIN EN ISO 4618:2015 defines the CPVC as a specific value for the PVC at which the cavities between the contacting solid particles of a coating are still just filled with binder. Above the CPVC (supercritical region), therefore, not all of the cavities are filled with binder. Below the CPVC (subcritical region), all of the cavities are filled with binder.

The coarse granulation usually contained in a plaster mass leads to the formation of air inclusions which are not all filled, so that the PVC of a plaster layer produced from a conventional plaster mass will always be in the supercritical region. In the case of plaster masses or plaster layers, then, information regarding the PVC is usually superfluous. The PVC information is only relevant if the coating contains finely divided pigments and fillers, so that dense packing of the pigments and fillers results from this. This is the case with paints and varnishes as well as with the plaster mass in accordance with the invention.

The dense packing of the fillers in the plaster mass in accordance with the invention leads to small voids or cavities and therefore to a low binder requirement in order to fill the voids or cavities. This means that the CPVC can be displaced to a higher value. By displacing the CPVC to a higher value, a PVC is obtained which is in the subcritical region, preferably between 40% and 80%, more preferably between 45% and 75%, particularly preferably between 50% and 70%. This means that all of the voids and cavities are filled with binder. The plaster mass or the plaster layer which is produced from it is therefore rich in binder, although it only contains a small quantity of binder because the dense packing of the fillers reduces the binder requirement.

By means of the proposed use of at least one polymer binder, all of the voids and cavities are filled with a comparatively elastic binder, in particular when compared with mineral or cement binders. As a result, this means that the elasticity of the plaster layer formed from a plaster mass in accordance with the invention can be increased further. This means that pecks can be absorbed even better.

Preferably, with respect to the total weight of the starting materials, it contains 3-15% by weight, preferably 4-12% by weight, more preferably 4-10% by weight of the at least one polymer binder. The proportion of binder is therefore comparatively low. Because of the dense packing of the fillers, however, the PVC remains in the subcritical region.

More preferably, the at least one polymer binder has a minimum film-forming temperature of 0° C. to 20° C. and/or a glass transition temperature of 5° C. to 15° C. The polymer binder is therefore comparatively elastic.

Preferably, it contains a polymer binder based on vinyl acetate/ethylene copolymers, copolymers based on vinyl aromatics, in particular styrene, and acrylates and/or homopolymers or copolymers based on pure acrylates, in particular based on styrene-acrylate copolymers, and/or pure acrylates comprising homopolymers or copolymers of acrylates and/or methacrylates, if appropriate with acrylic acid and/or methacrylic acid as the comonomer component. Homopolymers or copolymers based on pure acrylates and/or based on styrene-acrylate copolymers are preferred.

It is also proposed that it contains, respectively with respect to the total weight of the starting materials,
5-20% by weight, preferably 6-18% by weight, more preferably 7-15% by weight of the at least one coarse fillers,
15-30% by weight, preferably 16-28% by weight, more preferably 18-25% by weight of the at least one fine filler, and
20-50% by weight, preferably 25-45% by weight, more preferably 28-40% by weight of the at least one finest filler.

The proportions by weight which are given lead to very dense packing of the fillers when the given particle sizes for the individual size fractions are used.

Preferably, the fillers contain at least one silicate and/or carbonate filler such as, for example, quartz, cristobalite, calcite, marble and/or dolomite, wherein silicate fillers are usually harder than carbonate fillers so that, depending on the size fraction, one or the other type of filler or a mixture of both types of filler will be preferred. The fillers of a size fraction may therefore also comprise different types of filler or a mixture of fillers.

The at least one fine filler preferably has a Mohs hardness of at least 5, more preferably at least 6, particularly preferably at least 6.5. This means that it is comparatively hard. This minimises the risk of the fine filler becoming pulverized or crushed between the particles of the larger filler fraction. The at least one fine filler is therefore preferably a silicate filler, for example quartz or cristobalite.

It is furthermore proposed that it contains a first coarse filler with a Mohs hardness of a maximum of 5, preferably a maximum of 4, more preferably a maximum of 3, as well as a second coarse filler with a Mohs hardness of at least 5, preferably at least 6, more preferably at least 6.5, wherein the proportion by weight of the first coarse filler is larger than the proportion by weight of the second coarse filler. This means that the coarse fraction contains a mixture of different coarse fillers which differ at least as regards their Mohs hardness. In this regard, in the coarse fraction, the proportion by weight of the “soft” fillers predominates. This also contributes to the fact that the fine fillers between the coarse fillers are not pulverized or crushed, so that the fine fillers can act as robust spacers between the coarse fillers.

Furthermore, it is proposed that it contains a first finest filler with a Mohs hardness of a maximum of 5, preferably a maximum of 4, more preferably a maximum of 3, as well as a second finest filler with a Mohs hardness of at least 5, preferably at least 6, more preferably at least 6.5, wherein the proportion by weight of the first finest filler is smaller than the proportion by weight of the second finest filler. Thus, in similar manner to the coarse fillers, a finest filler mixture is present. However, in the case of the finest fillers, the ratio is inverted, i.e. it contains more hard fillers than soft fillers.

Particularly preferably, the finest fillers contain at least one finest filler with a Mohs hardness of 1 or 2. The proportion by weight of this very soft finest filler is preferably at least 5% by weight, more preferably at least 10% by weight, with respect to the total weight of the finest fillers. The particles of the very soft finest filler act as a kind of lubricant between the larger particles of the remaining filler fractions. In contrast to the particles of the at least one fine filler, the particles of the finest filler can easily be pulverised or crushed.

As an alternative or in addition to the aforementioned silicate and/or carbonate fillers, the at least one finest filler may contain oxide and/or hydroxide finest fillers, for example aluminium hydroxide. Adding aluminium hydroxide as the finest filler means that it contains a flame retardant at the same time, so that a separate flame retardant as an additive can be dispensed with.

The usual additives may be present in the proposed plaster mass as an additive, for example preservatives, fibres, wetting/dispersing agents, defoaming agents, water-repellent agents, accelerators, film-forming agents, dyes and/or colorants. The addition of carbon nanotubes has been shown to be particularly advantageous. These may be contained in it in a proportion by weight of up to 1% by weight.

More preferably, the additives contain at least one curing agent, preferably a curing agent based on a silane, in particular based on a polysiloxane. The curing agent stabilises the polymer binder. The proportion by weight of the curing agent may be up to 1% by weight with respect to the total weight of the starting materials.

Preferably, a plaster mass in accordance with the invention contains
3.0-15.0% by weight of at least one polymer binder (solid)
5.0-20.0% by weight of at least one coarse filler
15.0-30.0% by weight of at least one fine filler
20.0-50.0% by weight of at least one finest filler
10.0-30.0% by weight of water
0-1,0% by weight of curing agent
0,1-10.0% by weight of further additives respectively with respect to the total weight of the starting materials.

A plaster layer produced from this, in particular a reinforcing layer, has a certain elasticity, so that it is capable of at least partially absorbing a peck from a bird, in particular a woodpecker. The plaster layer is therefore less damaged, or not damaged at all, by the pecking. In particular, it may no longer be penetrated. This means that no woodpecker damage via which moisture could penetrate is generated in this plaster layer. The function of the plaster layer is therefore preserved.

Because of these advantages which may accrue with the aid of a plaster mass in accordance with the invention, furthermore, a single-layered or multi-layered plaster layer produced from a plaster mass in accordance with the invention, in particular a reinforcing layer, is proposed.

The advantages of a single-layered or multi-layered plaster layer formed from a plaster mass in accordance with the invention are particularly clear when they are used in a plaster system together with other plaster layers. Furthermore, therefore, a plaster system is proposed which comprises a single-layered or multi-layered plaster layer, in particular a reinforcing layer, formed from a plaster mass in accordance with the invention, as well as at least one further plaster layer, preferably a top coat layer and/or a further reinforcing layer, wherein the further reinforcing layer is cement bonded. This means that the plaster system may comprise two reinforcing layers, one organically, polymer bonded and one cement bonded. The polymer bonded reinforcing layer has a certain amount of elasticity in order to be able to thwart woodpecker damage. In contrast, the cement bonded reinforcing layer is rigid and provides the plaster system with greater strength.

In this regard, the plaster layer formed from a plaster mass in accordance with the invention is preferably disposed between a cement bonded, single-layered or multi-layered reinforcing layer with an inserted reinforcing mesh and a single-layered or multi-layered top coat layer, so that the plaster system comprises at least three layers. The plaster layer formed by the plaster mass in accordance with the invention is more preferably constructed in two layers, wherein a further reinforcing mesh may be embedded in the lower layer. If this is the case, the assembly is preferably in the substrate-side half of the lower layer. Usual or conventional reinforcing meshes may be used, for example a “4.5 oz mesh”.

Preferably, the single-layered or multi-layered plaster layer formed from a plaster mass in accordance with the invention has a layer thickness of 2.0-10.0 mm, preferably of 2.5-7.0 mm, more preferably of 3.0-6.0 mm. Thus, for polymer bonded plaster layers, comparatively large layer thicknesses may be obtained. This is due to the fact that comparatively little polymer binder is contained in it, so that the plaster layer rapidly produces a film or dries out.

The layer thickness of the single-layered or multi-layered plaster layer produced from the plaster mass in accordance with the invention is preferably larger than the layer thickness of the cement bonded reinforcing layer, so that the elasticity of the plaster layer produced from the plaster mass in accordance with the invention is not compromised by the rigid reinforcing layer which is under it.

The advantages of the invention will now be demonstrated with the aid of a specific exemplary embodiment. The exemplary embodiment illustrates a plaster mass in accordance with the invention for the production of a single-layered or multi-layered plaster layer, in particular a single-layered or multi-layered reinforcing layer.

### EXEMPLARY EMBODIMENT

| | | |
|---|---|---|
| 5.5 | % by wt | polymer binder, pure acrylate basis (solid) |
| 11.0 | % by wt | marble sand and quartz sand (D50 = approx. 1200 μm) |
| 22.0 | % by wt | quartz sand (D50 = approx. 280 μm) |
| 1.5 | % by wt | amorphous SiO₂ (D50 = approx. 60 μm) |
| 20.0 | % by wt | quartz powder (D50 = approx. 50 μm) |
| 6.0 | % by wt | talc (D50 = approx. 50 μm) |
| 10.0 | % by wt | aluminium hydroxide (D50 = approx. 20 μm) |
| 0.3 | % by wt | curing agent |
| 3.0 | % by wt | other additives |
| 20.7 | % by wt | water |
| 100 | % by wt | |

In order to produce a plaster mass in accordance with the invention, all of the starting materials were mixed homogeneously. The PVC of the plaster mass produced in accordance with the exemplary embodiment was approximately 58%.

Next, a plaster system in accordance with the invention was produced using the plaster mass produced in accordance with the exemplary embodiment. To this end, firstly, a 2.1 mm thick cement bonded reinforcing layer was applied to an EPS board. A further reinforcing layer produced from the plaster mass in accordance with the invention was applied to this, and in fact in two layers, wherein each layer was 2.1 mm thick. Next, a 1.5 mm thick top coat plaster was added on top of the second reinforcing layer.

After drying, the plaster system produced in this manner underwent a loading test, what is known as the “Bird Strike Resistance Test”. In this test, with the aid of a metal tip which imitates a beak strike, the plaster layer is repeatedly struck with a defined force. Next, the plaster layer is checked for damage. If the metal tip has penetrated into the plaster layer, the depth of penetration is measured and documented.

In the case of the loading test carried out on the plaster system in accordance with the invention, initially, a force of 22 N (±2 N) was applied a total of 25,000 times. The subsequent check for damage showed that the metal tip had penetrated into the plaster layer by a depth of 3.1 mm.

The same test was carried out on a plaster system which, instead of the second reinforcing layer produced from the plaster mass in accordance with the invention, had a second reinforcing layer produced from a conventional polymer bonded plaster mass and otherwise had the same construction. In this plaster system, the metal tip penetrated the plaster layers completely, and in fact after only 14600 strikes.

Other tests were carried out with a striking force of 32 N (±2 N) and a total of 28000 repetitions. In the plaster system which comprised a second reinforcing layer produced from a plaster mass in accordance with the invention, after 28000 strikes, a penetration depth of approximately 3.5 mm was observed for the metal tip. The plaster layers had therefore not penetrated completely.

The tests show that a plaster system in accordance with the invention has a significantly higher “Bird Strike Resistance”. Thus, the risk of woodpecker damage is significantly minimised.

1. A plaster mass for the formation of a single-layered or multi-layered plaster layer, in particular a reinforcing layer, containing
at least one polymer binder,
fillers,
additives, and
water,
wherein the fillers are present in a particle size distribution which is at least trimodal, comprising
at least one coarse filler with an average particle size D50 of 500-2000 μm, preferably 800-1800 μm, more preferably 1000-1600 μm,
at least one fine filler with an average particle size D50 of 100-500 μm, preferably 150-450 μm, more preferably 180-400 μm, and
at least one finest filler with an average particle size D50 of 5-99 μm, preferably 10-80 μm, more preferably 15-75 μm.

2. The plaster mass as claimed in claim 1, wherein with respect to the total weight of the starting materials, the plaster mass contains 3-15% by weight, of the at least one polymer binder.

3. The plaster mass as claimed in claim 1, wherein the at least one polymer binder has a minimum film-forming temperature of 0° C. to 20° C. and/or a glass transition temperature of 5° C. to 15° C.

4. The plaster mass as claimed in claim 1,
wherein the plaster mass it contains with respect to the total weight of the starting materials,
5-20% by weight, by weight of the at least one coarse filler,
15-30% by weight, by weight of the at least one fine filler, and
20-50% by weight, by weight of the at least one finest filler.

5. The plaster mass as claimed in claim 1,
wherein the fillers contain at least one silicate and/or carbonate filler.

6. The plaster mass as claimed in claim 1,
wherein the at least one fine filler has a Mohs hardness of at least 5.

7. The plaster mass as claimed in claim 1,
wherein the plaster mass contains a first coarse filler with a Mohs hardness of a maximum of 5, as well as a second coarse filler with a Mohs hardness of at least 5, wherein the proportion by weight of the first coarse filler is larger than the proportion by weight of the second coarse filler.

8. The plaster mass as claimed in claim 1,
wherein the plaster mass contains a first finest filler with a Mohs hardness of a maximum of 5, as well as a second finest filler with a Mohs hardness of at least 5, wherein the proportion by weight of the first finest filler is smaller than the proportion by weight of the second finest filler.

9. The plaster mass as claimed in claim 1,
wherein the at least one finest filler contains oxide and/or hydroxide finest fillers.

10. The plaster mass as claimed in claim 1,
wherein the additives contain at least one curing agent.

11. The plaster mass as claimed in claim 1, wherein it contains
3.0-15.0% by weight of at least one polymer binder (solid)
5.0-20.0% by weight of at least one coarse filler
15.0-30.0% by weight of at least one fine filler
20.0-50.0% by weight of at least one finest filler
10.0-30.0% by weight of water
0-1.0% by weight of curing agent
0.1-10.0% by weight of further additives respectively with respect to the total weight of the starting materials.

12. A single-layered or multi-layered plaster layer, produced from a plaster mass as claimed in claim 1.

13. A plaster system comprising a single-layered or multi-layered plaster layer produced from a plaster mass as claimed in claim 1
as well as at least one further plaster layer comprising one or more of a top coat layer and a cement bonded further reinforcing layer.

14. The plaster system as claimed in claim 13,
wherein the plaster layer produced from a plaster mass as claimed in claim 1 is disposed between a cement bonded single-layered or multi-layered reinforcing layer with an inserted reinforcing mesh and a single-layered or multi-layered top coat layer.

15. The plaster system of claim 13,
wherein the single-layered or multi-layered plaster layer formed from a plaster mass has a layer thickness of 2.0-10.0 mm.

16. The plaster mass as claimed in claim 1 wherein with respect to the total weight of the starting materials the plaster mass contains 4-12% by weight of the at least one polymer binder.

17. The plaster mass as claimed in claim 1 wherein with respect to the total weight of the starting materials the plaster mass contains 6-18% by weight of the at least one coarse filler, 16-28% by weight of the at least one fine filler, and 25-45% by weight of the at least one finest filler.

18. The plaster mass as claimed in claim 5 wherein the filler comprises one or more of quartz, cristobalite, calcite, marble or dolomite.

19. The plaster mass as claimed in claim 9 wherein the at least one finest filler comprises aluminum hydroxide.

20. The plaster mass as claimed in claim 10 wherein the additives comprise a polysiloxane.
